(19) United States
(12) Patent Application Publication
(10) Pub. No.: US 2016/0298937 A1
(43) Pub. Date: Oct. 13, 2016

(54) EDGE REINFORCEMENT FOR BALLISTIC LAMINATES

(71) Applicant: Tencate Advanced Armor USA, Inc., Newark, OH (US)

(72) Inventor: Jason Woodall, Hebron, OH (US)

(21) Appl. No.: 14/661,363

(22) Filed: Mar. 18, 2015

Related U.S. Application Data
(60) Provisional application No. 61/954,811, filed on Mar. 18, 2014.

(51) Int. Cl. F41H 5/04; B32B 7/12; B32B 27/06

(52) U.S. Cl. CPC F41H 5/0478; B32B 27/06; B32B 7/12; B32B 2571/02; B32B 2262/106

(57) ABSTRACT

A high performance composite ballistic laminate includes a composite panel forming a primary ballistic protective portion of the ballistic laminate and a composite feature comprising an angled portion extending from a plane defined by the composite panel. The composite feature may be bonded to the composite panel or integrally formed with the composite panel. The ballistic laminate may include at least one support layer bonded to at least a portion of the composite panel and at least a portion of the composite feature for delamination control. The angled portion may extend from the plane of the composite panel at an angle of from about 30 degrees to about 150 degrees. The ballistic laminate may satisfy at least one of NIJ Standard 0108.01 and NIJ Standard 0101.04 Level IIIA at a distance of less than 0.5″ from the edge of the ballistic laminate.

### RELATED APPLICATION

The present application claims the benefit of U.S. provisional application No. 61/954,811 filed Mar. 18, 2014, the contents of which are incorporated herein by this reference in its entirety.

### FIELD OF THE INVENTION

The present invention relates to ballistic laminates which provide protection against impacting projectiles, and in particular to ballistic laminates having a feature that extends the effectiveness of the ballistic laminate to its edge.

### BACKGROUND

Composite materials offer a weight benefit over conventional armor materials such as steel and aluminum. The composite materials used for armor are typically constructed of high strength fibers in a polymer matrix. Typical fibers include (but are not limited to) S-glass, aramids, polyethylene, and carbon fiber. The fibers may be woven to produce a rolled product or they could be a unidirectional material where the fibers in each layer are all oriented in one direction. Matrices are typically epoxy, phenolic, vinyl ester, neoprene, urethanes, polyethylene, etc.

These materials work through deformation and fiber strength to dissipate energy and slow an incoming projectile. Fibers near the strike side of an armor panel fail both through shear and strain. As shown in FIG. 1, as a projectile 10 impacts a panel 20 and passes through the layers thereof, it is slowed and ultimately stopped through strain and deformation of the composite material. The deformation is expected and works very well throughout most of a panel 20. However, performance decreases as a projectile 10 impacts near an edge 30. This is due to the delamination which is a primary mechanism of projectile 10 defeat by composite materials. Decreased performance is typically observed starting at approximately one to two inches from an edge 30, depending on the particular material. As shown in FIG. 2, when a projectile 10 impacts very close to an edge 30, the panel 20 might deform and move away from the path of the projectile 10, letting it pass with minimal effect on the velocity and trajectory of the projectile.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Embodiments of the invention relate to a high performance composite ballistic laminate including a composite panel forming a primary ballistic protective portion of the ballistic laminate and a composite feature having an angled portion extending from the plane of the composite panel.

The composite feature may be bonded to the composite panel or may be integrally formed with the composite panel.

In some embodiments, the ballistic laminate includes at least one support layer bonded to at least a portion of the composite panel and at least a portion of the composite feature. The support layer may provide delamination control for the composite feature.

The composite feature may be bonded to the composite panel with a resin or adhesive. Further, the at least one support layer may be bonded to at least a portion of the composite panel and at least a portion of the composite feature with a resin or adhesive.

The composite feature may include at least one of a polyethylene fiber, polyethylene tape, carbon, aramid, S-glass, spider silk, and combinations thereof. In some embodiments the composite feature includes unidirectional polyethylene tape.

The composite panel may include high strength fibers in a polymer matrix, the high strength fibers including at least one of S-glass, aramids, polyethylene, carbon fiber and combinations thereof. The polymer matrix may include at least one of epoxy, phenolic, vinyl ester, neoprene, urethane, polyethylene and combinations thereof. In certain embodiments the composite panel includes unidirectional polyethylene fibers in a polyurethane matrix.

The composite feature may extend from the plane of the composite panel at an angle of from about 30 degrees to about 150 degrees. In some embodiments the composite feature extends from the plane of the composite panel at an angle of from about 75 degrees to about 115 degrees.

The ballistic laminate may satisfy at least one of NIJ Standard 0108.01 and NIJ Standard 0101.04 Level IIIA at a distance of less than 1″ from the at least one edge of the ballistic laminate. In certain embodiments the ballistic laminate satisfies at least one of NIJ Standard 0108.01 and NIJ Standard 0101.04 Level IIIA at a distance of less than 0.5″ from the at least one edge of the ballistic laminate.

In certain embodiments a high performance composite ballistic laminate includes a composite panel forming a primary ballistic protective portion of the ballistic laminate and having a composite feature bonded to at least a portion of the composite panel with a resin or adhesive, the composite feature having an angled portion extending from the plane of the composite panel. The ballistic laminate further includes at least one support layer bonded to at least a portion of the composite panel and at least a portion of the composite feature, the at least one support layer providing delamination control for the composite feature.

In yet other embodiments a high performance composite ballistic laminate includes a composite panel forming a primary ballistic protective portion of the ballistic laminate and a composite feature integrally formed with the composite panel, the composite feature extending from the plane of the composite panel.

### BRIEF DESCRIPTION OF THE DRAWINGS

Illustrative embodiments of the present invention are described in detail below with reference to the following drawing figures:

FIG. 1 is a side view depicting an impacting projectile away from the edge of prior art high strength composite.

FIG. 2 is a side view depicting an impacting projectile close to the edge of prior art high strength composite.

FIG. 3 is a side view showing an edge reinforcement according to an embodiment of the invention in which a composite feature is bonded to a composite panel.

FIG. 4 is a side view depicting an impacting projectile close to the edge reinforcement of an embodiment of the invention.

FIG. 5 shows the impacting projectile of FIG. 4 at a later point in time.

FIG. 6 is a side view showing an edge reinforcement according to another embodiment of the invention in which a composite feature is integrally bonded with a composite panel.

FIG. 6A is a side view of an embodiment of the invention showing a curved angle between the composite feature and composite panel.

FIG. 6B is a side view of an embodiment of the invention showing the composite feature extending from the composite panel at an angle other than about 90 degrees.

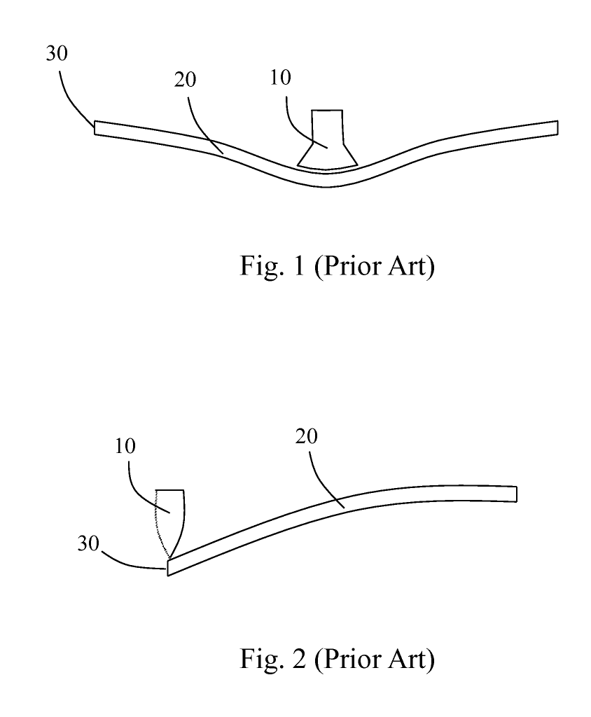

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

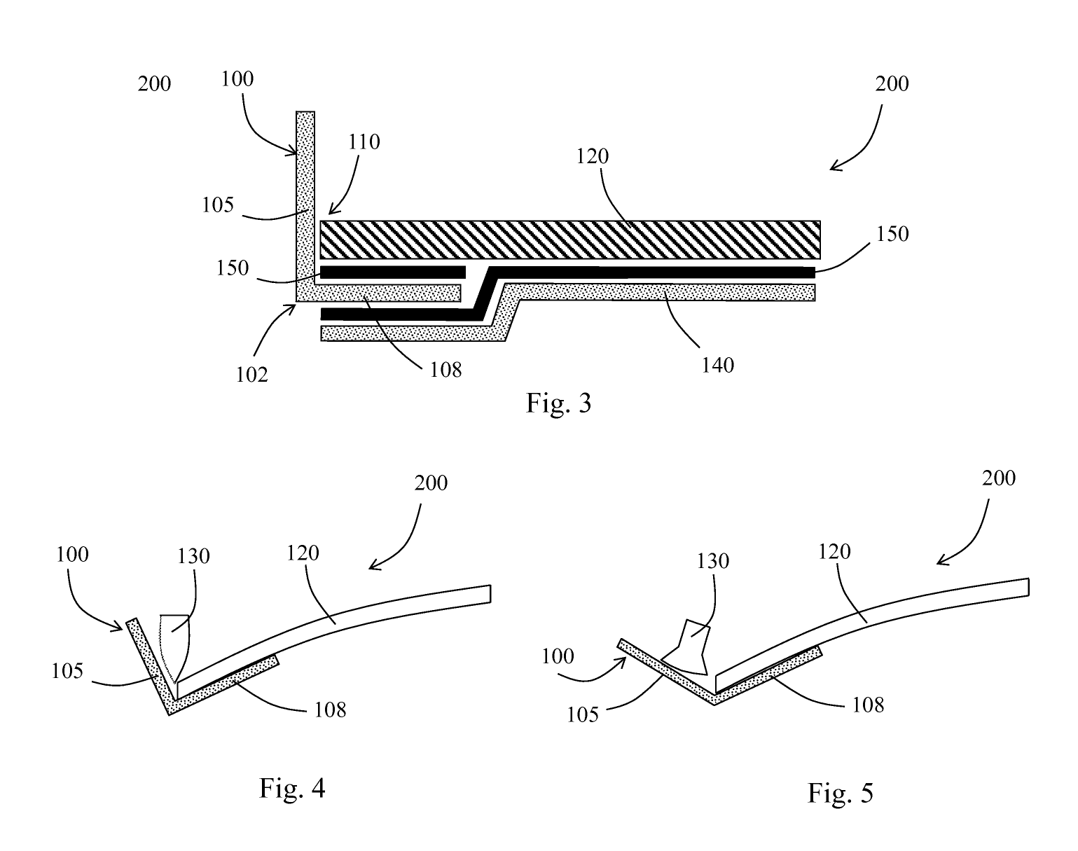

With reference to FIG. 3, embodiments of the invention provide a ballistic laminate 200 having a composite feature 100 provided at the edge 110 of a composite panel 120. The composite feature 100 includes a formed angle 102 or curve that extends from the plane of the composite panel, and could include any composite material which has some inherent ballistic performance. The composite feature 100 is designed such that the composite panel 120 can be placed close to the extents of the area to be protected and such that the height of the composite feature 100 does not protrude beyond the surface of the composite panel 120 any more than necessary to meet a given set of requirements. FIGS. 4 and 5 demonstrate the performance of the composite feature 100 of the present invention. With the composite feature 100 added to the edge 110, the composite panel 120 still deforms during impact by a projectile 130 as shown in FIG. 4. The composite feature 100 reinforces the edge 110 with higher areal density and higher stiffness and effectively moves the edge 110 of the composite panel 120 out by the height of the composite feature 100. This is more particularly shown in FIG. 5, as the composite feature 100 deforms and extends outwardly, extending the effective length of the composite panel 120.

In some embodiments, the composite feature 100 is a unidirectional material, such as but not limited to a unidirectional polyethylene tape material such as Tensylon™ 30A or Dyneema® BT10. Unidirectional polyethylene tape offers a compromise of high deformation and stiffness. Other composite materials are known and within the scope of this invention, however. For example, in some embodiments the composite feature 100 could include higher or lower strength materials such as polyethylene fiber, carbon, aramid, S-glass, spider silk, combinations thereof, or others.

The composite panel 120 forms the primary ballistic protective portion of the ballistic laminate 200, and may be formed of any suitable ballistic materials, such as high strength fibers in a polymer matrix. Suitable high strength fibers include, but are not limited to, S-glass, aramids, polyethylene, carbon fiber and combinations thereof. Suitable materials for the polymer matrix include, but are not limited to, epoxy, phenolic, vinyl ester, neoprene, urethane, polyethylene and combinations thereof. The fibers may be woven to produce a rolled product or they could be a unidirectional material where the fibers in each layer are all oriented in one direction. In one embodiment, the composite panel is a unidirectional fiber material including polyethylene fibers embedded in a polyurethane matrix, one example of which is Dyneema® HB-210, available from DSM Dyneema.

This material, like other similar materials, is provided in a roll of two or more layers of laminated unidirectional fibers that are cross-plied by 90 degrees with adjacent layers. The material is removed from the roll and cut into sheets, and the sheets are stacked on top of one another until a desired composite thickness is reached and then pressed under high pressure and heat until the sheets are laminated to one another. A resin system could be, but does not necessarily have to be, used between the layers to promote adhesion. For example, a 1/10″ thick sheet of composite panel 120 may have about 36-40 layers of fibers. Composite panels up to or even greater than 6″ thick can be formed using similar processes by simply stacking more sheets on top of each other and laminating them as described herein.

Further, while in some embodiments the composite panel 120 is generally flat, it will be recognized that it could also be shaped (e.g., curved) as desired for a particular application. The composite panel 120 could be shaped by molding or otherwise manipulating it during its manufacture so that it retains the desired shape after processing, according to known processes.

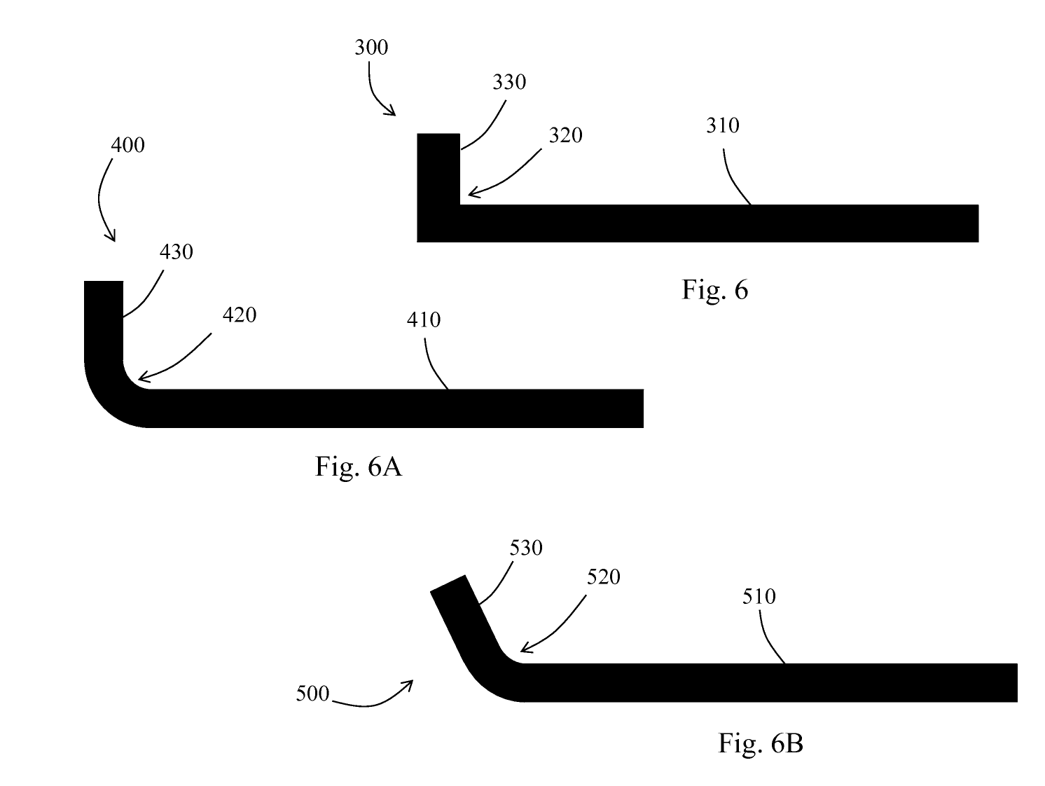

In certain embodiments, the angled portion 105 of the composite feature 100 extends from the edge 110 of the composite panel 120 at an angle 102 of approximate 90 degrees and is located adjacent the edge 110 of the composite panel 120. In other embodiments, however, the angled portion 105 of the composite feature could extend from other angles (see, e.g., the embodiment illustrated in FIG. 6B), for example from about 30 degrees to about 150 degrees, or from about 45 degrees to about 135 degrees. In certain embodiments, the angle could be from about 30 degrees to about 100 degrees or from about 75 degrees to about 135 degrees. Further, while not shown as such in FIG. 3, the angle between the angled portion 105 of the composite feature 100 and the composite panel 120 may be curved (see, e.g., the embodiment illustrated in FIGS. 6A and 6B).

In addition, the composite feature 100 could be curved (not illustrated). The composite feature 100 could be formed by placing the uncured material for the composite feature (e.g., Tensylon™ 30A) into the desired shape and then curing it under vacuum or autoclave pressure using known techniques. In other embodiments, the composite feature 100 could be formed under high pressure using shaped tooling, a high tonnage press, or in a custom mold to create the desired profile.

The length of the angled portion 105 of the composite feature 100 is selected such that it is sufficiently high/ deep to add enough protection to defeat the projectile of interest, while not being so high/deep so as to detract from the performance of the object (e.g., vehicle) on which the ballistic laminate 200 is installed. In some purely exemplary embodiments, the angled portion 105 of the composite feature 100 has a length of from about 0.6″ to about 0.75″. Such lengths have been found to provide desirable ballistic performance while minimizing the increase in weight and height/depth (“space claim”) of the ballistic laminate 200. Ballistic laminates 200 having a composite feature 120 with an angled portion 105 in these lengths have also been found to be easier to integrate into the platform (e.g., armored vehicle) than those having longer angled portions.

While the composite feature 100 added to the edge of the composite panel 120 has added ballistic protection, it might be prone to delamination from the composite panel 120 during an impact. If the composite feature 100 delaminates completely, it could become a harmful projectile itself (i.e., a “secondary projectile”) even though it has captured the projectile/threat. To counter this effect, one or more support layers 140 of composite material can be added to at least a portion of the back face of the composite panel 120 overlapping at least a portion of the composite feature 100. The one or more support layers 140 may be formed of any material that provides suitable performance. In some embodiments, the one or more support layers 140 can be formed from Tensylon™ 30A.

The one or more support layers could be secured to the composite feature 100 and composite panel 120 with one or more resin or adhesive layers 150 such as, but not limited to, Nolax adhesives or Surlyn® by DuPont™. One purely exemplary material for the adhesive layers 150 is Nolax A21.2007, a thermoplastic hotmelt adhesive film available from Nolax AG.

The use of one or more resin or adhesive layers 150 may be desirable based on the specific materials selected and the expected threats the armor configuration is intended to protect against. Some embodiments described herein may utilize one or more resin or adhesive layers 150 due to varying material combinations that benefit from additional adhesives designed for use with materials such as those described herein.

The one or more support layers 140 could be applied to the ballistic laminate 200 by placing the uncured material for the one or more support layer (e.g., Tensylon™) into the desired position and then curing it under vacuum pressure using known techniques. In other embodiments, the one or more support layers 140 could be formed under high pressure using shaped tooling to create the desired profile. In certain embodiments, one or more resin or adhesive layers 150 may be used to bond/adhere the one or more support layers 140 to at least a portion of the composite panel 120 and composite feature 100.

The increased bond area of the one or more support layers 140 can prevent the composite feature 100 from disbanding completely from the ballistic laminate 200 and becoming a secondary projectile. The one or more support layers 140 added to the back face of the ballistic laminate 200 might cover the entire back surface of the ballistic laminate 200 or only a portion extending from the edge (or near the edge) toward the center of the ballistic laminate 200 to some distance determined to be sufficient to prevent the composite feature 100 from becoming a secondary projectile. In some exemplary embodiments, the bonded length 108 of composite feature 100 (i.e., the portion of the composite feature 100 that is parallel to composite panel 120) may be around two to three times the height/depth of the angled portion 105 of the composite feature 100. For example, it may be desirable for a composite feature 100 having an angled portion 105 with a height of about 0.6″ to 0.75″ to have a bonded length 108 of about 1.5″.

In some embodiments of the invention, the composite feature may be integrally formed with the composite panel, as shown in FIGS. 6, 6A and 6B. A ballistic laminate 300, 400, 500 includes a composite panel 310, 410, 510 and a composite feature 330, 430, 530 that extends at an angle 320, 420, 520 from the plane of the composite panel 310, 410, 510. In some embodiments the angle 320, 420 may be approximately 90 degrees (see FIGS. 6 and 6A). In other embodiments the angle 520 could be from about 30 degrees to about 150 degrees, or from about 45 degrees to about 135 degrees, or from about 30 degrees to about 100 degrees (see FIG. 6B). In addition, the composite feature itself could be curved (not illustrated). The composite feature 330, 430, 530 may be integrally formed with the composite panel 310, 410, 510, and the angle 320, 420, 520 could be formed by processing the composite panel 310, 410, 510 to create the desired angle and shape (e.g., straight angle or curve). The ballistic laminate 300, 400, 500 including a composite feature 330, 430, 530 such as those described herein may also be formed using any suitable method described herein, including but not limited to vacuum pressing, autoclave pressing, shaped tooling, high tonnage pressing and custom molding.

Ballistic laminates 100, 300, 400, 500 formed according to the methods and/or having the configurations described herein may satisfy various standards for ballistic resistant protective materials, including but not limited to National Institute of Justice (NIJ) Standard 0108.01 and NIJ Standard 0101.04 Level IIIA. In addition, the ballistic laminates may satisfy one or more of these standards with a projectile impacting very close to the edge of the ballistic laminate (i.e., on or very near the angled portion 105 of the composite feature 100 or on the composite feature 330, 430, 530). In contrast to prior ballistic panels (see, e.g., FIG. 2), in which ballistic performance decreases significantly as the center of impact of the projectile gets closer than two inches from the edge of the ballistic panel, the inclusion of a composite feature according to embodiments of the invention can provide acceptable performance with a projectile impacting such that the center of impact is as little as one-half of the diameter (e.g., 0.22″ for a 44 Magnum) of the bullet from the edge of the ballistic laminate. In other words, the projectile (bullet) can strike substantially tangent to the composite panel (120, 310, 410, 510) and still satisfy one or more of the ballistic standards described herein. Such performance effectively increases the area of ballistic performance beyond the edge of the composite panel (120, 310, 410, 510). Thus, in certain embodiments of the invention the composite panel satisfies at least one of NIJ Standard 0108.01 and NIJ Standard 0101.04 Level IIIA within 1″ of the edge of the ballistic laminate, or within 0.5″ of the edge of the ballistic laminate, or within a distance of one-half of the diameter of the projectile from the edge of the ballistic laminate.

While the invention is described herein as protecting against projectile threats, it will be recognized that it would be suitable against other types of ballistic/impacting threats (e.g., shrapnel).

The present invention is further illustrated by the following examples which illustrate specific embodiments of the invention but are not meant to limit the invention.

### EXAMPLE 1

A ballistic laminate was formed with the following components and according to the process described:
Composite panel:
   0.5 pounds per square foot (psf) (18 plies) of Dyneema® HB-210 formed by pressing the plies at a pressure of greater than 2500 psi
Composite feature:
   42 plies of Tensylon™ 30A
   Cured in an over using a mold under vacuum to form an angle of approximately 90 degrees
   Composite feature was waterjet cut such that:
      The portion perpendicular to the composite panel was 0.6″ to 0.75″ long
      The portion parallel and bonded to the back surface of the composite panel was approximately 1.5″ long
Support feature (delamination control):
   6 plies of Tensylon™ 30A
   Bonded to the composite feature/composite panel under vacuum in an oven
Adhesive layers:
   50 grams per square meter (gsm) Nolax A21.2007
   Used to bind the composite feature to the composite panel and the support feature to the composite feature/composite panel

It was found that the ballistic laminate satisfied the NIJ 0108.01 and NIJ 0101.04 level IIIA standards. Each of these standards involves shooting multiple 44 Magnum and/or 9 mm bullets into a single ballistic sample. NIJ 0101.04 specifies, inter alia, a 240 grain 44 Magnum Jacketed Hollow Point while NIJ 0108.01 specifies, inter alia, a 240 grain 44 Magnum Lead Semi-Wadcutter Gas Checked bullet. Further, in contrast to previous laminates that did not include a composite feature and which started to show degradation in performance when the projectile (bullet) impacted within about 2″ from the edge of the ballistic panel, the ballistic laminate described above was able to satisfy these standards when the projectile impacted almost tangent to the ballistic laminate (i.e., less than 0.25″ from the edge of the ballistic laminate, or close to one-half of the diameter of the bullet from the edge).

It is anticipated that the overall thickness of the composite panel, and thus the overall weight of the ballistic laminate, may be able to be reduced due to the improved performance of the ballistic laminate of the example described above.

### EXAMPLE 2

The ballistic laminate of Example 1 was formed except that the 0.5 psf Dyneema® HB-210 composite panel was replaced with 0.75 psf Dyneema® HB-80. Although the HB-80 material is generally a lesser-performing material than HB-210, similar results were achieved as those described in Example 1; the ballistic laminate of this example satisfied the NIJ 0108.01 and NIJ 0101.04 level IIIA standards.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A high performance composite ballistic laminate having at least one edge, the ballistic laminate comprising:
a composite panel forming a primary ballistic protective portion of the ballistic laminate, the composite panel defining a plane; and
a composite feature comprising an angled portion extending from the plane of the composite panel.

2. The ballistic laminate of claim 1, wherein the composite feature is bonded to the composite panel.

3. The ballistic laminate of claim 1, wherein the composite feature is integrally formed with the composite panel.

4. The ballistic laminate of claim 1, further comprising at least one support layer bonded to at least a portion of the composite panel and at least a portion of the composite feature, wherein the at least one support layer provides delamination control for the composite feature.

5. The ballistic laminate of claim 4, wherein
the composite feature is bonded to the composite panel with a resin or adhesive, or
the at least one support layer is bonded to at least a portion of the composite panel and at least a portion of the composite feature with a resin or adhesive.

6. The ballistic laminate of claim 1, wherein the composite feature comprises at least one of a polyethylene fiber, polyethylene tape, carbon, aramid, S-glass, spider silk, and combinations thereof.

7. The ballistic laminate of claim 1, wherein the composite feature comprises unidirectional polyethylene tape.

8. The ballistic laminate of claim 1, wherein the composite panel comprises high strength fibers in a polymer matrix,
the high strength fibers comprising at least one of S-glass, aramids, polyethylene, carbon fiber and combinations thereof, and
the polymer matrix comprising at least one of epoxy, phenolic, vinyl ester, neoprene, urethane, polyethylene and combinations thereof.

9. The ballistic laminate of claim 1, wherein the composite panel comprises unidirectional polyethylene fibers in a polyurethane matrix.

10. The ballistic laminate of claim 1, wherein the composite feature extends from the plane of the composite panel at an angle of from about 30 degrees to about 150 degrees.

11. The ballistic laminate of claim 1, wherein the ballistic laminate satisfies at least one of NIJ Standard 0108.01 and NIJ Standard 0101.04 Level IIIA at a distance of less than 0.5″ from the at least one edge of the ballistic laminate.

12. A high performance composite ballistic laminate having at least one edge, the ballistic laminate comprising:
a composite panel forming a primary ballistic protective portion of the ballistic laminate, the composite panel defining a plane;
a composite feature bonded to at least a portion of the composite panel with a resin or adhesive, the composite feature comprising an angled portion extending from the plane of the composite panel; and
at least one support layer bonded to at least a portion of the composite panel and at least a portion of the composite feature, wherein the at least one support layer provides delamination control for the composite feature.

13. The ballistic laminate of claim 12, wherein:
the composite feature comprises at least one of a polyethylene tape, carbon, aramid, S-glass, spider silk, and combinations thereof; and
the composite panel comprises high strength fibers in a polymer matrix,
the high strength fibers comprising at least one of S-glass, aramids, polyethylene, carbon fiber and combinations thereof, and
the polymer matrix comprising at least one of epoxy, phenolic, vinyl ester, neoprene, urethane, polyethylene and combinations thereof.

14. The ballistic laminate of claim 12, wherein the composite panel comprises unidirectional polyethylene fibers in a polyurethane matrix and the composite feature comprises unidirectional polyethylene tape.

15. The ballistic laminate of claim 12, wherein the angled portion extends from the plane of the composite panel at an angle of from about 30 degrees to about 150 degrees.

16. The ballistic laminate of claim 12, wherein the ballistic laminate satisfies at least one of NIJ Standard 0108.01 and NIJ Standard 0101.04 Level IIIA at a distance of less than 0.5″ from the at least one edge of the ballistic laminate.

17. A high performance composite ballistic laminate having at least one edge, the ballistic laminate comprising:
a composite panel defining a plane and forming a primary ballistic protective portion of the ballistic laminate; and
a composite feature integrally formed with the composite panel, the composite feature extending from the plane of the composite panel.

18. The ballistic laminate of claim 17, wherein the ballistic laminate comprises high strength fibers in a polymer matrix,
the high strength fibers comprising at least one of S-glass, aramids, polyethylene, carbon fiber and combinations thereof, and
the polymer matrix comprising at least one of epoxy, phenolic, vinyl ester, neoprene, urethane, polyethylene and combinations thereof.

19. The ballistic laminate of claim 17, wherein the composite feature extends from the plane of the composite panel at an angle of from about 30 degrees to about 150 degrees.

20. The ballistic laminate of claim 17, wherein the ballistic laminate satisfies at least one of NIJ Standard 0108.01 and NIJ Standard 0101.04 Level IIIA at a distance of less than 0.5″ from the at least one edge of the ballistic laminate.
